(19) United States
(12) Patent Application Publication
(10) Pub. No.: US 2004/0031053 A1
(43) Pub. Date: Feb. 12, 2004

(54) Method for providing HDTV-level multimedia service and communication system therefor

(76) Inventors: Jong-Hoon Lim, Suwon-shi (KR); Ki-Yeon Sung, Suwon-shi (KR); Kyong-Joon Chun, Seoul (KR); Young-Jip Kim, Suwon-shi (KR)

Correspondence Address: Robert E. Bushnell, Suite 300, 1522 K Street, N.W., Washington, DC, 20005, US

(21) Appl. No.: 10/444,131

(22) Filed: May 23, 2003

(30) Foreign Application Priority Data
Aug. 8, 2002 (KR) 2002-46758
Jan. 17, 2003 (KR) 2003-3338

(51) Int. Cl. H04N 7/173; H04N 5/225

(52) U.S. Cl. 725/86

(57) ABSTRACT

A communication system for providing an HDTV (High Definition Television)-level multimedia service over a VDSL (Very-high-data-rate Digital Subscriber Line). The communication system comprises a client terminal device in a subscriber residence, a service provider, and an access network. The terminal device allows a user of the client terminal device to access a network through the VDSL. The service provider provides HDTV-level multimedia service programs and includes a zapping server. The zapping server accepts an HDTV-level multimedia service request signal of a channel requested by the user of the client terminal device, responds to the client terminal device, and provides one of the HDTV-level multimedia service programs corresponding to the channel requested by the user of the client terminal device. The access network is connected between the service provider and the client terminal device, and provides a optical communication path there between so that the client terminal device can receive the one of the HDTV-level multimedia service programs through the subscriber line.

### CLAIM OF PRIORITY

This application makes reference to, incorporates the same herein, and claims all benefits accruing under 35 U.S.C § 119 from an application entitled High Definition Television Quality Guaranteed Multimedia Service Method and Communication System Therefor, filed in the Korean Industrial Property Office on Aug. 8, 2002 and assigned Application No. 2002-46758 and an application entitled High Definition Television Quality Guaranteed Multimedia Service Method and Communication System Therefor, filed in the Korean Industrial Property Office on Jan. 17, 2003 and assigned Application No. 2003-3338.

### BACKGROUND OF THE INVENTION

1. Field of the Invention

The present invention relates to a method for providing a multimedia service, and more particularly to a method and a system for providing an HDTV (High Definition Television)-level multimedia service.

2. Description of the Related Art

The number of Internet users increases sharply owing to the development of ultra high-speed Internet services using a cable modem, ADLS (Asynchronous Digital Subscriber Line), etc. As desire for interactive applications increases, the users increasingly move from a one-way 5 Internet service to a more advanced two-way Internet service. In addition, the current trend is that users want to receive HDTV-level multimedia services such as HDTV viewing, HDTV-level VoD (Video on Demand), selection of programs on the Web, and digital-camera broadcasting.

The VoD service needs high bandwidth due to the properties of multimedia data, and therefore it is currently used in limited places such as a hotel and the inside of a plane. In such places, a system for providing the VoD service mostly uses a dedicated line because the distance between the VoD server and individual users is short. Thus, such a system for providing the VoD service has a problem that, because of the characteristics of the multimedia data, an additional cost is needed to install a dedicated line for securing a high bandwidth in order to implement the VoD service between a service provider and individual users.

The VoD service is also available based on the Internet using a cable modem or ADSL, etc. However, the Internet-based VoD service does not provide a high-quality VoD service due to factors such as difficulty of securing sufficient bandwidth in the communication network, and a characteristic of IP (Internet Protocol), i.e., a lack of ability to provide QoS (Quality of Service). Thus, a VoD service through the Internet has frequently experienced disconnection during the service and also fails to provide a high-quality screen.

Korean unexamined Publication No. 1999-58089 entitled “Transmission System For Providing A Multimedia Service” has disclosed a subscriber's transmission system for providing a multimedia service. However, this prior art cannot provide an HDTV-level multimedia service such as HDTV viewing and HDTV-level VoD.

### SUMMARY OF THE INVENTION

Therefore, the present invention has been made in view of the above problems, and it is an object of the present invention to provide a method and a system for providing an HDTV-level multimedia service such as HDTV viewing and HDTV-level VoD.

It is another object of the present invention to provide a method and a system for providing an HDTV-level VoD service using a VDSL technology.

It is yet another object of the present invention to provide a method and a system for providing an HDTV-watching service using a VDSL (very high-data-rate digital subscriber line, a.k.a., very high-speed digital subscriber line) technology.

In accordance with one aspect of the present invention, the above and other objects can be accomplished by the provision of a communication system for providing an HDTV-level multimedia service, the communication system comprising: a client terminal device in a subscriber residence for allowing a user of the client terminal device to access a network through a subscriber line; a service provider for providing HDTV-level multimedia service programs that can be transmitted to the client terminal device; a zapping server included in the service provider for (a) accepting an HDTV-level multimedia service request signal of a channel requested by the user of the client terminal device, (b) responding to the client terminal device, and (c) providing one of the HDTV-level multimedia service programs corresponding to the channel requested by the user of the client terminal device; and an access network connected between the service provider and the client terminal device for providing a communication path there between so that the client terminal device can receive the one of the HDTV-level multimedia service programs through the subscriber line.

In accordance with another aspect of the present invention, there is provided a communication system for providing an HDTV-level multimedia service, the communication system comprising: a client terminal device in a subscriber residence for allowing a user of the client terminal device to access a network through a VDSL; a multimedia-service providing device for providing HDTV-level multimedia service programs including HDTV broadcast programs and HDTV-level VoD (Video on Demand) content programs; a zapping server for (a) accepting an HDTV-level multimedia service request signal of a channel requested by the user of the client terminal device, (b) responding to the client terminal device, and (c) providing one of the HDTV-level multimedia service programs corresponding to the channel requested by the user of the client terminal device; and an access network connected between the zapping server and the client terminal device for providing a communication path therebetween so that the client terminal device can receive the one of the HDTV-level multimedia service programs through the VDSL.

In accordance with still another aspect of the present invention, there is provided a method for providing an HDTV-level multimedia service in a communication system including a service provider and an access network, the service provider providing HDTV-level multimedia service programs and an Internet access service to a user of a client terminal device in a subscriber residence, the access network being connected to the service provider through an optical cable and connected to the client terminal device through a VDSL, the method comprising the steps of: a) transmitting a program guide information on an HDTV multimedia service from the service provider to the client terminal device, while performing exchange of a message defined by a channel zap protocol between the service provider and the client terminal device; and b), when the client terminal device issues a program selection request based on the program guide information, transmitting an HDTV multimedia service program, selected from the HDTV multimedia service programs according to the program selection request, from the service provider to the client terminal device through the access network and the VDSL.

In accordance with yet another aspect of the present invention, there is provided a method for providing an HDTV-level multimedia service in a communication system including a service-providing device, a zapping server, and an access network, the service-providing device providing HDTV-level multimedia service programs to a user of a client terminal device in a subscriber residence, the zapping server (i) accepting an HDTV-level multimedia service request signal of a channel requested by the user of the client terminal device, (ii) responding to the client terminal device, and (iii) providing one of the HDTV-level multimedia service programs corresponding to the channel requested by the user of the client terminal device, the access network being connected to the zapping server through an optical cable and connected to the client terminal device through VDSL, the method comprising the steps of: a) transmitting a client-session-setup request message for setting up a client session from the client terminal device to the zapping server; b), after the zapping server confirms registration of the user based on the client-session-setup request message in response to the client-session-setup request message, transmitting a client-session-setup confirmation message including guide information on video programs available to be provided to the user of the client terminal device, from the zapping server to the client terminal device; c), after the client session is set up, transmitting a program-selection request message for requesting the zapping server to provide a program selected according to a channel request issued by the user of the client terminal device, from the client terminal device to the zapping server; and d), after the zapping server receives the program selection request message and confirms whether the selected program can be transmitted through the service-providing device, transmitting a program selection confirmation message as an answer whether the selected program can be transmitted, from the zapping server to the client terminal device.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the is accompanying drawings in which like reference symbols indicate the same or similar components, wherein:

FIG. 1 is a view showing the configuration of a communication system for providing an HDTV-level multimedia service using the VDSL technology according to an embodiment of the present invention;

FIG. 2 is a view illustrating a basic channel zap protocol according to the embodiment of the present invention;

FIG. 3 is a view illustrating the flow of messages such as the session control and the channel change performed by the channel zap protocol according to the embodiment of the present invention; and

FIG. 4 is a view illustrating information contained in the messages such as the session control and the channel change.

FIG. 5 is a flow chart showing the session control procedure of a zapping server according to the embodiment of the present invention.

### DETAILED DESCRIPTION OF THE PREFERRED EMBODIMENTS

Now, a preferred embodiment of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

FTTH (Fiber To The Home) technology is the best way to realize an HDTV-level multimedia service such as HDTV viewing and VoD service that requires a high bandwidth. To this end, it is necessary to install an optical fiber up to the home. However, the optical fiber installation up to the home has many problems, such as high cost. 10022] The best solution of the problem is a VDSL technology, whose full-scale service is expected in the near future. The VDSL technology is one of the xDSL (Digital Subscriber Line: ADSL, VDSL, SDSL, RADSL, HDSL, etc.) technologies that enable ultra high-speed Internet service. Of the xDSL technologies, VDSL can provide HDTV-level multimedia services such as HDTV viewing, and an HDTV-level VoD.

The VDSL technology has a transmission distance shorter than the ADSL (Asymmetric DSL) technology. However, in the case of short transmission distance about 500 m (usually in the range of 300 m to 1.5 km), the VDSL technology shows an excellent transmission ratio, allowing the provision of the HDTV-level multimedia service such as HDTV viewing or HDTV-level VoD.

In more detail, the VDSL technology has an asymmetric data communication mode 3.4 times as fast as the ADSL technology and is suitable for providing a service of transmitting large-capacity contents such as high-definition VoD, real-time video chatting, Internet broadcast, etc. In addition, because the VDSL technology uses the existing twisted pair copper telephone line (POTS: plain old television service), it can be easily implemented without special facilities, and also allows an audio communication simultaneously with an Internet communication.

An embodiment of the present invention provides such a communication system that an optical fiber is installed up to an ONU (optical network unit) located near the home or the company, like the concept of FTTC (Fiber To The Curb); data transfer is made optically from an HDT (Host Digital Terminal), connected to a service provider through an ATM switch, to the ONU; and services are provided from the ONU to each end user at home or in the company, through the VDSL using the telephone line.

In order to realize the provision of the HDTV-level multimedia service such as HDTV viewing and HDTV-level VoD service requiring a high bandwidth by means of the VDSL technology, it is necessary, first of all, to realize a function to accept and respond to a multimedia service request signal for one channel, such as channel change or selection request signals. This is because of the following facts. All the HDTV-level multimedia service programs, for example, service programs of about 1.6 Gbps transmitted from a service-providing server, can be carried to the ONU (optical network unit) through the optical cable connected between the ONU and the HDT (Host Digital Terminal) that is connected to the service provider. Each channel-bandwidth of the HDTV-level multimedia service programs is about 20 Mbps. However, only about one channel-bandwidth of the HDTV-level multimedia service programs can be transmitted from the ONU to each user at home or in the company through the VDSL using the telephone line. This is because the maximum allowable bandwidth of the VDSL is about 40 Mbps a little higher than one channel-bandwidth (about 20 Mbps) of the HDTV-level multimedia service programs, and the actual bandwidth of the VDSL is about 30 Mbps.

For this reason, in the embodiment of the present invention, there is provided a zapping server in the service provider in order to allow the provision of the HDTV-level multimedia service such as HDTV viewing and VoD service using VDSL technology, and a protocol is implemented between the zapping server and the client to enable a function of accepting and responding to a multimedia service request signal such as a channel change or selection request signal. This allows the zapping server to transmit an HDTV-level multimedia program selected by the user of the client to the client.

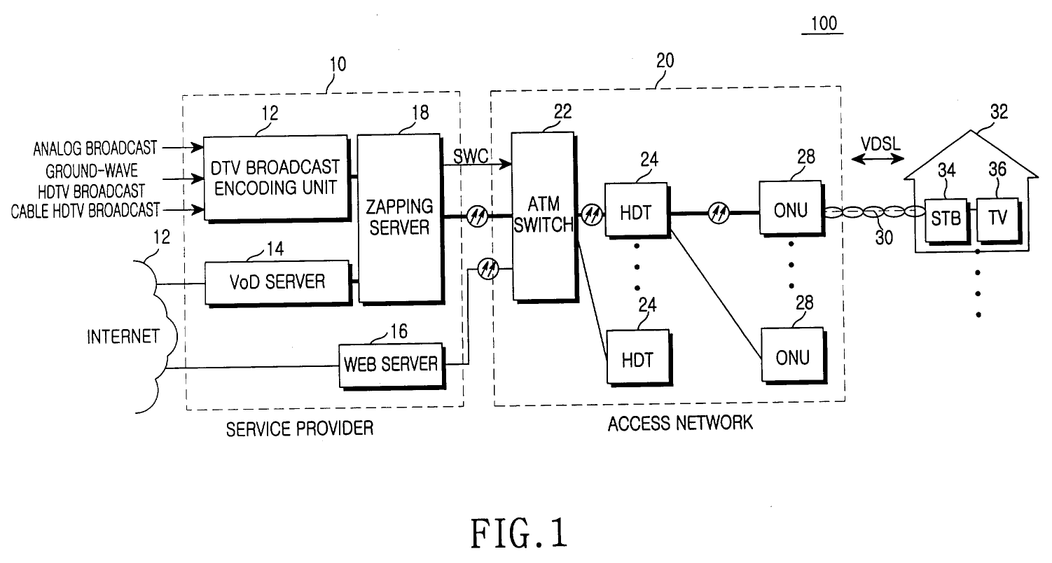

FIG. 1 is a view showing the configuration of a communication system for providing an HDTV-level multimedia service using the VDSL technology according to the embodiment of the present invention.

Referring to FIG. 1, the communication system 100 includes basically a service provider 10 including a zapping server 18 according to the present invention, an access network 20, and a subscriber residence 32 as a client that includes customer premises equipment (CPE), referred to herein as a client set-top box (STB) 34.

The service provider 10 includes a DTV (Digital Television) broadcast encoding unit 12, a VoD server 14, a service-providing device composed of a web server 16, and a zapping server 18. The service-providing device provides an HDTV broadcast service, a VoD service, and also provides an Internet access service to the user of the client set-top box (STB) 34 in the subscriber residence 32.

The DTV broadcast encoding unit 12 receives an analog signal such as CATV (cable television) broadcast signal and MPEG-encodes the received signal to be converted to an SDTV-level MPEG TS (Standard TV-level Moving Picture Expert Group Transport Stream), and also receives a ground-wave HDTV broadcast signal or a cable HDTV broadcast signal and converts the received signal to an HDTV-level MPEG TS, and then provides the converted SDTV or HDTV-level MPEG TS to the zapping server 18.

The VoD server 14 has stored an HDTV-level VoD content, and provides the zapping server 18 with an MPEG TS of the content corresponding to a VoD service request from the STB set-top box (STB) 34 in the subscriber residence 32.

The web server 16, generally called “a remote access server”, performs an IP (Internet Protocol) address assignment and provides a verification service in order to connect the set-top box (STB) 34 to the Internet 12 according to the Internet access request from the user of the set-top box (STB) 34 in the subscriber residence 32.

The zapping server 18 functions to accept a multimedia service request signal of the user, such as a channel change or selection request signal from the set-top box (STB) 34 in the subscriber residence 32, and to respond to the client set-top box (STB) 34. In addition, the zapping server 18 functions to receive an HDTV-level multimedia service program of the channel requested by the set-top box (STB) 34 from the DTV broadcast encoding unit 12 or the VoD server 14 and transfer the received program to the set-top box (STB) 34.

The subscriber residence 32 includes the client set-top box (STB) 34 and a TV (television) 36 connected to the set-top box (STB) 34. The TV (television) 36 may be an HDTV that can receive an HDTV-level multimedia service such as an HDTV broadcast or HDTV-level VoD content.

The access network 20 is located between the service provider 10 and the subscriber residence 32. The access network is connected to the service provider 10 through an optical cable, and is connected to the set-top box (STB) 34 in the subscriber residence 32 through the VDSL 30. Thus, the access network 20 provides a communication path between the service provider 10 and the set-top box (STB) 34 in the subscriber residence 32, so as to allow the user to receive the HDTV-level VoD content program and the HDTV broadcast program and have Internet access through the VDSL 30.

As one example of using an ATM-PON (Asynchronous Transfer Mode—Passive Optical Network), the access network includes an ATM switch 22, a plurality of ONUs (Optical Network Units) 28, and a plurality of HDTs (Host Digital Terminals) 24 as fiber-optic subscriber units. This HDT is called OLT (Optical Line Terminal) in the ATM-PON.

The ONUs 28 are connected to the HDTs 24 through optical cable, and connected to the set-top box (STB) 34 in the subscriber residence 32 through the VDSL 30, thereby providing an interface between the optical cable and the VDSL 30. The HDTs 24 are connected to the ATM switch 22 and the ONUs 28 through the optical cable, and function to multiplex upstream signals transmitted from the STB24 in the subscriber residence 32 to the service provider 32 through the ONU 28, as well as demultiplex downstream signals transmitted from the service provider 32 to the set-top box (STB) 34 in the subscriber residence 32 through the ONU 28.

The ATM switch 22 is connected to the web server 16 and the zapping server 18 of the service provider I 0. The ATM switch 22 functions to transmit the MPEG TS of HDTV-level VoD content program or HDTV broadcast program of the channel as an ATM cell, which is selected based on a switch control signal SWC from the zapping server 18, to the set-top box (STB) 34 in the subscriber residence 32 through the HDT 24. In addition, in response to establishing Internet access by the user of the STM 34 in the subscriber residence, the ATM switch 22 establishes a communication between the STM 34 and the web server 16.

In the case where the subscriber residence 32 is an ordinary home, the ONUs 28 are located separately from the subscriber residence 32, and on the other hand, in the case where it is one of a hospital, a hotel, a company, a broadcast station, etc., the ONUs 28 are located in the subscriber residence 32.

The HDTs 24 and the ONUs 28 are located up to a few km distant from each other, and connected to each other through at least a 2.5Gbps optical cable. The ONUs 28 and the subscriber residence 34 are located up to 300 m distant from each other, and connected to each other through the VDSL 30 of 36 Mbps-downstream and 3.6 Mbps-upstream.

In order to provide the HDTV-level multimedia service using the VDSL technology in the present embodiment, it is necessary to realize a function to accept and respond to a signal related to a service request such as a session control or a channel change. The session control is necessary to establish a setup for exchanging messages between terminals and perform a synchronous control for exchanging data therebetween.

In order to accomplish such a function, the service provider 10 is provided with the zapping server 18 according to the embodiment of the present invention. While messages defined by a channel zap protocol according to the embodiment of the present invention are exchanged between the client set-top box (STB) 34 and the zapping server 18, a program guide information on the HDTV-level broadcasting and a program guide information on the HDTV-level VoD content are transferred from the zapping server 18 to the set-top box (STB) 34.

In response to a request from the client set-top box (STB) 34, the zapping server 18 transmits the switch control signal SWC to the ATM switch 22 in the access network 20 so as to adjust the value of a VPI/VCI (Virtual Path Identifier/Virtual Channel Identifier), thereby changing the channel. In addition, the zapping server 18 receives an HDTV-level multimedia service program of the channel desired by the set-top box (STB) 34 from the DTV broadcast encoder 12 or the VoD server 14 and transmits the received program to the set-top box (STB) 34 through the access network 20.

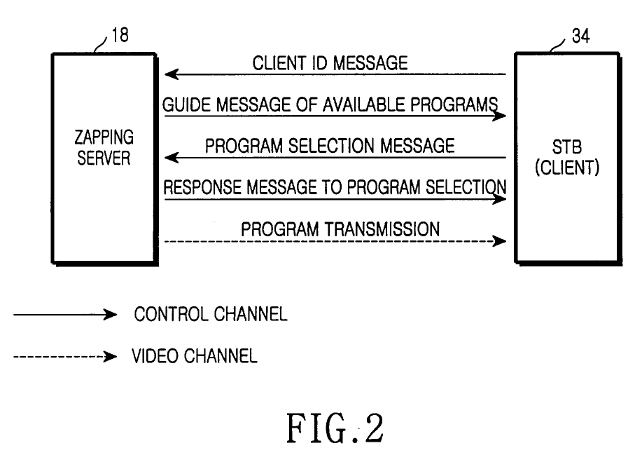

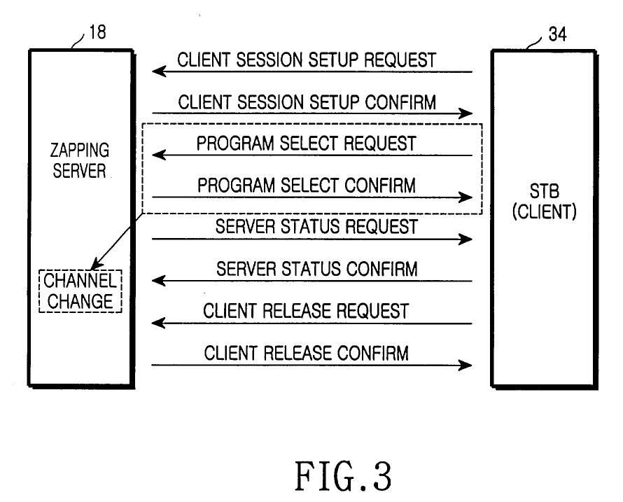

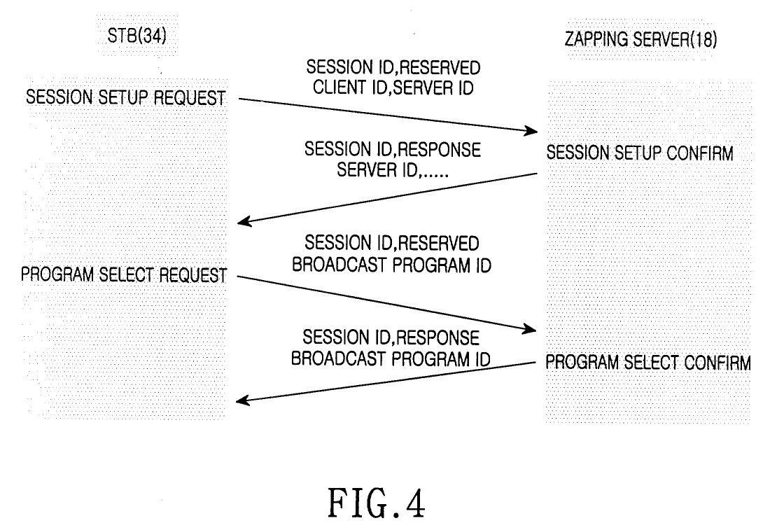

FIG. 2 is a view illustrating a basic channel zap protocol according to the embodiment of the present invention. FIG. 3 is a view illustrating the flow of messages such as the session control and the channel change performed by the channel zap protocol according to the embodiment of the present invention. FIG. 4 is a view illustrating information contained in the messages such as the session control and the channel change.

First, an explanation is made about the basic channel zap protocol according to the embodiment of the present invention, referring to FIG. 2. Initially, a client set-top box (STB) 34 transmits a client ID (identifier) message including the zapping server's own ID to the zapping server 18 through a control channel. In response to this, the zapping server 18 performs a verification process for the client ID message, and then transfers a program guide message on available programs to the set-top box (STB) 34. When the user of the set-top box (STB) 34 selects a program desired by the user, the set-top box (STB) 34 transfers information on the selected program, i.e., a program selection message to the zapping server 18 through a control channel. Upon receipt of the program selection message, the zapping server 18 transmits a response message of the program selection to the set-top box (STB) 34. Thereafter, the zapping server 18 transfers one channel of HDTV-level multimedia service program, i.e., an HDTV-level program selected by the user to the set-top box (STB) 34, through a video channel.

As mentioned above, while messages defined by the channel zap protocol are exchanged between the zapping server 18 and the client set-top box (STB) 34, only the HDTV-level multimedia program selected by the user is transmitted from the zapping server 18 to the set-top box (STB) 34 through the access network 20 and the VDSL 30. Accordingly, since the VDSL 30 can carry only about one channel of HDTV-level multimedia service program, the HDTV-level multimedia program can be transferred to the set-top box (STB) 34 through the VDSL 30.

The procedure of the flow of messages such as the session control and the channel change is now described in detail, referring to FIGS. 3 and 4. First, the session control is described below.

1) Session Control

As shown FIG. 3, the set-top box (STB) 34 transmits a message ClientSessionSetupRequest to the zapping server 18. As shown in FIG. 4, the message ClientSessionSetupRequest includes a session ID, a reserved client ID, and a server ID. The server ID is an ID representing the zapping server 18.

After confirming the registration of the user using the received message ClientSessionSetupRequest, the zapping server 18 transmits a message ClientSessionSetupConfirm, which includes the guide information of video programs available to be provided to the user, to the set-top box (STB) 34. As shown in FIG. 4, the message ClientSessionSetupConfirm includes a session ID, a server ID, etc. When the set-top box (STB) 34 receives the message ClientSessionSetupConfirm, the session setup is established.

With the session setup established, the set-top box (STB) 34 repeats the procedure of channel change together with the zapping server 18, each time the user requests the channel change. The channel change is described in detail in section “2) CHANNEL CHANGE” below.

The zapping server 18 periodically transfers a present-status inquiring message ServerStatusRequest to the set-top box (STB) 34 to be informed of the status of the set-top box (STB) 34. Upon receipt of the message ServerStatusRequest, the set-top box (STB) 34 transfers a message ServerStatusConfirm to the zapping server 18.

For termination of the operation of the set-top box (STB) 34, the set-top box (STB) 34 5 transmits a message ClientReleaseRequest to the zapping server 18. The zapping server 18 confirms the termination of the operation of the set-top box (STB) 34, using the received message ClientReleaseRequest, and transmits a message ClientReleaseConfirm to the set-top box (STB) 34, in response to the received message.

2) Channel Change

2-1) When Set-Top Box (STB) 34 Requests a Channel Change

The client set-top box (STB) 34 transmits a message ProgramSelectRequest to the zapping server 18 to request the zapping server 18 to provide a program selected according to a channel change request from the user of the set-top box (STB) 34. As shown in FIG. 4, the ProgramSelectRequest message includes a session ID, and a reserved broadcast program ID. In response to the request, the zapping server 18 confirms whether the selected program can be transmitted through the DTV broadcast encoding unit 12 or the VoD server 14, and then transmits a response message ProgramSelectConfirm to the set-top box (STB) 34 to answer whether the selected program can be transmitted. As shown in FIG. 4, the message ProgramSelectConfirm includes a session ID and a response broadcast program ID.

2-2) When the Zapping Server 18 Requests a Channel Change as an Optional Operation

The zapping server 18 inserts information, which is to inform the set-top box (STB) 34 of the fact that the present program is forcibly switched to a defined program, in a message ProgramSelectlndication (not shown) to be transmitted on the channel to the set-top box (STB) 34, and transmits the message ProgramSelectIndication (not shown) to the set-top box (STB) 34. Upon receipt of the message ProgramSelectIndication, the set-top box (STB) 34 transmits a response message ProgramSelectResponse (not shown) to the zapping server 18.

Hereinafter, a description is given of a method for providing the client set-top box (STB) 34 with an HDTV-level multimedia service such as HDTV viewing or HDTV-level VoD, using the VDSL technology.

First, the method for providing an HDTV-viewing service is described as follows.

TV Viewing

1. The DTV broadcast encoding unit 12 MPEG-encodes an analog signal such as a CATV (cable television) broadcast to be converted to an SDTV-level MPEG TS (Moving Picture Expert Group Transport Stream), and converts a ground-wave HDTV broadcast signal or a cable HDTV broadcast signal to an HDTV-level MPEG TS, so that the signal can be broadcasted to the Is ATM switch 22 through the zapping server 18.

2. The set-top box (STB) 34 exchanges a channel zap protocol message (Request, Confirm) with the zapping server 18 to obtain channel information.

3. When the client set-top box (STB) 34 selects a desired channel through the zapping protocol, the zapping server 18 applies the switch control signal SWC to the ATM switch 22 to change the channel of the ATM switch 22, allowing the user to watch one HDTV broadcast program. That is, in response to the switch control signal SWC, the VPI/VCI values of the ATM switch 22 are adjusted to connect the channel to a VCI value for going over to the HDT 24, so that the set-top box (STB) 34 can receive the one channel of HDTV broadcast transmitted from the zapping server 18.

4. In the procedure of changing the channel, the set-top box (STB) 34 transmits a channel change information to the zapping server 18, and the zapping server 18 changes the channel by the same method as described in the previous paragraph 3.

Now, the method for providing an HDTV-level VoD service is described as follows.

VoD Service

1. The set-top box (STB) 34 requests a program guide information on the HDTV-level VoD service from the zapping server 18.

2. The zapping server 18 receives the program guide information on the VoD content from the VoD server 14, and transmits the received information to the set-top box (STB) 34.

3. When the set-top box (STB) 34 requests a specific HDTV-level VoD content program, the VoD server 14 pumps the requested specific HDTV-level VoD program to the ATM switch 22.

4. At this time, the zapping server 18 connects the channel of the VoD content program to a VCI value for going over to the HDT 24, whereby a service of one channel of HDTV-level VoD program is provided to the user.

When a session setup is established between the zapping server 18 and the client set-top box (STB) 34 as mentioned above, the zapping server 18 functions to accept a multimedia service request signal of a channel, such as a channel change or a channel selection, from the client set-top box (STB) 34, and transmit a response to the client set-top box (STB) 34.

It should be noted, however, that the network connection between the client set-top box (STB) 34 and the zapping server 18 or the service provider server (for example, an HDTV broadcast device, a VoD server and/or a Web server) may be abnormally terminated. If such an abnormal disconnection occurs, the session established between the client set-top box (STB) 34 and the zapping server 18 or the service provider server is abnormally terminated, which permits the service provider server to continue the service provision to the client set-top box (STB) 34.

In order to prevent such a waste of resources, the present invention enables the sever to periodically check the status of the client set-top box (STB) 34 through the message ServerStatusRequest. This message is transmitted to the client set-top box (STB) 34 one by one at intervals of a predetermined time, for example, 30 minutes. The transmission period of the message (corresponding to the predetermined time) may vary depending on the particular system being utilized. If there is no response from the client set-top box (STB) 34, the server retransmits the message ServerStatusRequest to the client set-top box (STB) 34. If the client set-top box (STB) 34 does not respond to the retransmitted message ServerStatusRequest, the server transmits a message ReleaseRequest to the client set-top box (STB) 34 to terminate the established session.

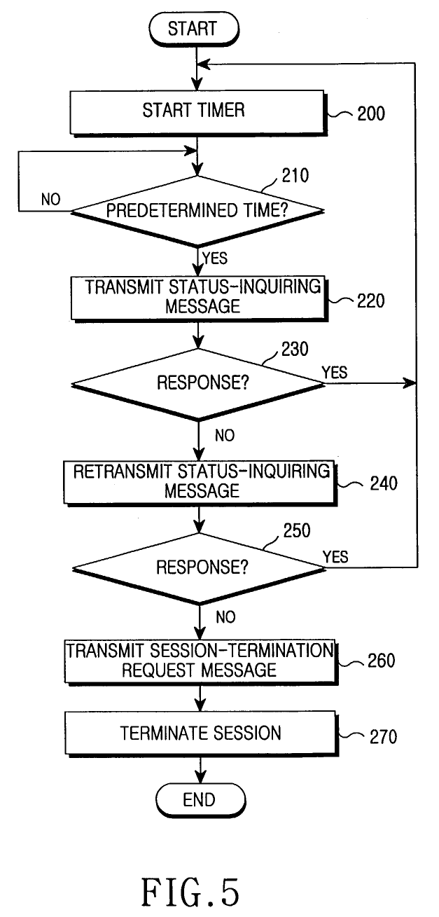

Referring now to FIGS. 1 and 5, the session control procedure of the zapping server 18 is described in detail as follows. As shown in FIG. 1, while the session is established with the client set-top box (STB) 34, the zapping server 18 periodically checks the status of the client set-top box (STB) 34. The zapping server 18 operates a timer so as to check the status of the client set-top box (STB) 34 when the timer reaches a predetermined time.

In more detail, referring to FIG. 5, the zapping server 18 starts the timer at step 200, and checks whether the current time reaches a predetermined time, or whether a predetermined time period has elapsed, in step 210. When it is determined that the current time reaches the predetermined time, or that the predetermined time period has elapsed, the zapping server 18 transmits a status inquiring message, for example, the ServerStatusRequest message, to the client set-top box (STB) 34 at step 220. At step 230, the zapping server 18 checks for a response from the client set-top box (STB) 34. If there is a response from the client set-top box (STB) 34, the process in zapping server 18 returns to step 200 to restart the timer.

If there is no response from the client set-top box (STB) 34, the zapping server 18 retransmits the status inquiring message to the client set-top box (STB) 34 at step 240, and checks for a response at step 250 from the client set-top box (STB) 34. If there is a response from the client set-top box (STB) 34, the process in zapping server 18 returns to step 200 to restart the timer.

Note here that steps 240 and 250 could be replaced by repeating steps 220 and 230, then the “NO” result from step 230 could be followed by a determination as to whether these steps had been repeated a predetermined number of times (not shown) to be followed by step 260 if it is determined that steps 220 and 230 had been repeated the predetermined number of times.

If it is determined in step 250 that there is no response from the client set-top box (STB) 34, the zapping server transmits in step 260 a session termination message, for example, a message ReleaseRequest, to the client set-top box (STB) 34. Subsequently, in step 270, the zapping server terminates the session with the client set-top box (STB) 34.

As apparent from the above description, the present invention has an advantage in that a digital broadcast service such as an HDTV-level MPEG-2 VoD and an HDTV-level TV watching can be provided based on the VDSL technology using the existing telephone line without an additional installation of a dedicated line in buildings such as a house, a hotel, a school, and a company.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A communication system for providing an HDTV (High Definition Television)-level multimedia service, the communication system comprising:
a client terminal device in a subscriber residence for allowing a user of the client terminal device to access a network through a subscriber line;
a service provider for providing HDTV (High Definition Television)-level multimedia service programs that can be transmitted to the client terminal device;
a zapping server included in the service provider for (a) accepting an HDTV (High Definition Television)-level multimedia service request signal of a channel requested by the user of the client terminal device, (b) responding to the client terminal device, and (c) providing one of the HDTV (High Definition Television)-level multimedia service programs corresponding to the channel requested by the user of the client terminal device; and
an access network connected between the service provider and the client terminal device for providing a communication path therebetween so that the client terminal device can receive said one of the HDTV (High Definition Television)-level multimedia service programs through the subscriber line.

2. The communication system as set forth in claim 1, wherein the subscriber line is a VDSL (Very-high-data-rate Digital Subscriber Line).

3. The communication system as set forth in claim 2, wherein the access network includes:
a plurality of ONUs (Optical Network Units) connected to the client terminal device through the VDSL (Very-high-data-rate Digital Subscriber Line) for providing an interface between the VDSL (Very-high-data-rate Digital Subscriber Line) and an optical cable;
at least one HDT (Host Digital Terminal) connected to the ONUs (Optical Network Units) through the optical cable for multiplexing upstream signals transmitted from the client terminal device to the service provider through the ONUs (Optical Network Units), and demultiplexing a downstream signals transmitted from the service provider to the client terminal device through the ONUs (Optical Network Units); and
an ATM (Asynchronous Transfer Mode) switch connected to the service provider as well as connected to the HDT (Host Digital Terminal) through an optical cable for transmitting said one of the HDTV (High Definition Television)-level multimedia service programs to the client terminal device through the HDT (Host Digital Terminal), based on a switching control of the zapping server.

4. The communication system as set forth in claim 1, further comprising said zapping server periodically transmitting a status inquiring message to said client terminal device in order to ascertain a communication status with the client terminal device.

5. The communication system as set forth in claim 4, further comprising said zapping server determining whether a response message to said status inquiring message is received from said client terminal device, and when it is determined that no response message is received from said client terminal device in response to said status inquiring message, said zapping server retransmitting said status inquiring message to said client terminal device, said zapping server terminating communication with said client terminal device when it is determined that no response message is received from said client terminal device in response to the retransmission of said status inquiring message, said zapping server retransmitting said status inquiring message a predetermined number of times to said client terminal device before terminating communication with said client terminal device.

6. A communication system for providing an HDTV (High Definition Television)-level multimedia service, the communication system comprising:
a client terminal device in a subscriber residence for allowing a user of the client terminal device to access a network through a VDSL (Very-high-data-rate Digital Subscriber Line);
a multimedia-service providing device for providing HDTV (High Definition Television)-level multimedia service programs including HDTV (High Definition Television) broadcast programs and HDTV (High Definition Television)-level VoD (Video on Demand) content programs;
a zapping server for accepting an HDTV (High Definition Television)-level multimedia service request signal of a channel requested by the user of the client terminal device, responding to the client terminal device, and providing one of the HDTV (High Definition Television)-level multimedia service programs corresponding to the channel requested by the user of the client terminal device; and
an access network connected between the zapping server and the client terminal device for providing a communication path therebetween so that the client terminal device can receive said one of the HDTV (High Definition Television)-level multimedia service programs through the VDSL (Very-high-data-rate Digital Subscriber Line).

7. The communication system as set forth in claim 6, wherein the client terminal device is a set-top box.

8. A method for providing an HDTV (High Definition Television)-level multimedia service in a communication system including a service provider and an access network, said service provider providing HDTV (High Definition Television)-level multimedia service programs and an Internet access service to a user of a client terminal device in a subscriber residence, said access network being connected to the service provider through an optical cable and connected to the client terminal device through a VDSL (Very-high-data-rate Digital Subscriber Line), the method comprising the steps of:
a) transmitting a program guide information on an HDTV (High Definition Television) multimedia service from the service provider to the client terminal device, while performing exchange of a message defined by a channel zap protocol between the service provider and the client terminal device; and
b), when the client terminal device issues a program selection request based on the program guide information, transmitting an HDTV (High Definition Television) multimedia service program, selected from the HDTV (High Definition Television) multimedia service programs according to the program selection request, from the service provider to the client terminal device through the access network and the VDSL (Very-high-data-rate Digital Subscriber Line).

9. The method as set forth in claim 8, wherein the HDTV (High Definition Television)-level multimedia service programs include at least HDTV (High Definition Television) broadcast programs and HDTV (High Definition Television)-level VoD content programs.

10. The method as set forth in claim 8, wherein the channel zap protocol includes at least the course of the flow of messages of channel change and session control.

11. A method for providing an HDTV (High Definition Television)-level multimedia service in a communication system including a service-providing device, a zapping server, and an access network, said service-providing device providing HDTV (High Definition Television)-level multimedia service programs to a user of a client terminal device in a subscriber residence, said zapping server (i) accepting an HDTV (High Definition Television)-level multimedia service request signal of a channel requested by the user of the client terminal device, (ii) responding to the client terminal device, and (iii) providing one of the HDTV (High Definition Television)-level multimedia service programs corresponding to the channel requested by the user of the client terminal device, said access network being connected to the zapping server through an optical cable and connected to the client terminal device through VDSL (Very-high-data-rate Digital Subscriber Line), the method comprising the steps of:
a) transmitting a client-session-setup request message for setting up a client session from the client terminal device to the zapping server;
b) after the zapping server confirms registration of the user based on the client-session-setup request message in response to the client-session-setup request message, transmitting a client-session-setup confirmation message including guide information on video programs available to be provided to the user of the client terminal device, from the zapping server to the client terminal device;
c) after the client session is set up, transmitting a program-selection request message for requesting the zapping server to provide a program selected according to a channel request issued by the user of the client terminal device, from the client terminal device to the zapping server; and
d) after the zapping server receives the program selection request message and confirms whether the selected program can be transmitted through the service-providing device, transmitting a program-selection confirmation message as an answer whether the selected program can be transmitted, from the zapping server to the client terminal device.

12. The method as set forth in claim 11, wherein the client-session-setup request message includes at least a session ID (identifier), a reserved client ID (identifier), and a server ID (identifier) representing the zapping server.

13. The method as set forth in claim 11, wherein the client-session-setup confirmation message includes at least a session ID (identifier) and a server ID (identifier).

14. The method as set forth in claim 11, wherein the program-selection request message includes at least a session ID (identifier) and a reserved broadcast program ID (identifier).

15. The method as set forth in claim 11, wherein the program-selection confirmation message includes at least a session ID (identifier) and a response broadcast program ID (identifier).

16. The method as set forth in claim 11, further comprising a step of periodically transmitting a status inquiring message to said client terminal device from said zapping server in order to determine a communication status between said client terminal device and said zapping server.

17. The method as set forth in claim 16, further comprising steps of:
determining whether a response message to said status inquiring message is received by said zapping server from said client terminal device;
when it is determined that no response message is received from said client terminal device in response to said status inquiring message, retransmitting said status inquiring message to said client terminal device from said zapping server; and
terminating communication with said client terminal device when it is determined that no response message is received from said client terminal device in response to the retransmission of said status inquiring message.

18. The method as set forth in claim 17, further comprising steps of:
performing said step of retransmitting said status inquiring message a predetermined number of times;
checking for the response message after each retransmission of said status inquiring message; and
terminating said communication with said client terminal device when it determined that the response message was not received by said zapping server after retransmitting said status inquiring message said predetermined number of times.

19. A communication system for providing an HDTV (High Definition Television)-level multimedia service, the communication system having a client terminal device in a subscriber residence for allowing a user of the client terminal device to access a network through a subscriber line, a service provider for providing HDTV (High Definition Television)-level multimedia service programs that can be transmitted to the client terminal device, an access network connected between the service provider and the client terminal device for providing a communication path therebetween so that the client terminal device can receive one of the HDTV (High Definition Television)-level multimedia service programs through the subscriber line, and a zapping server included in the service provider, said zapping server comprising a processor including a channel zap protocol programmed to:
accept an HDTV (High Definition Television)-level multimedia service request signal of a channel requested by the user of the client terminal device,
respond to the client terminal device, and
provide said one of the HDTV (High Definition Television)-level multimedia service programs corresponding to the channel requested by the user of the client terminal device.

20. The communication system as set forth in claim 19, said channel zap protocol further programmed to:
periodically transmit a status inquiring message to said client terminal device in order to ascertain a communication status with the client terminal device;
determine whether a response message to said status inquiring message is received from said client terminal device;
retransmit said status inquiring message to said client terminal device, when it is determined that no response message is received from said client terminal device in response to said status inquiring message;
terminate communication with said client terminal device when it is determined that no response message is received from said client terminal device in response to the retransmission of said status inquiring message.

21. The communication system as set forth in claim 20, said channel zap protocol further programmed to:
retransmit said status inquiring message a predetermined number of times to said client terminal device before terminating communication with said client terminal device.

22. The communication system as set forth in claim 19, said channel zap protocol further programmed to:
receive a client-session-setup request message for setting up a client session from the client terminal device;
confirm registration of the user in response to the client-session-setup request message;
transmit a client-session-setup confirmation message including guide information on available video programs to the user of the client terminal device;
receive a program-selection request message for requesting the zapping server to provide a program selected according to the channel requested by the user of the client terminal device;
confirm whether the selected program can be transmitted in response to the program selection request message; and
transmit to the client terminal device a program-selection confirmation message as an answer to whether the selected program can be transmitted to the client terminal device.

23. The communication system as set forth in claim 22, wherein the client-session-setup request message includes at least a session ID (identifier), a reserved client ID (identifier), and a server ID (identifier) representing the zapping server.

24. The communication system as set forth in claim 22, wherein the client-session-setup confirmation message includes at least a session ID (identifier) and a server ID (identifier).

25. The communication system as set forth in claim 22, wherein the program-selection request message includes at least a session ID (identifier) and a reserved broadcast program ID (identifier).

26. The communication system as set forth in claim 22, wherein the program-selection confirmation message includes at least a session ID (identifier) and a response broadcast program ID (identifier).

27. The communication system as set forth in claim 22, said channel zap protocol further programmed to:
periodically transmit a status inquiring message to said client terminal device in order to ascertain a communication status with the client terminal device;
determine whether a response message to said status inquiring message is received from said client terminal device;
retransmit said status inquiring message to said client terminal device, when it is determined that no response message is received from said client terminal device in response to said status inquiring message;
terminate communication with said client terminal device when it is determined that no response message is received from said client terminal device in response to the retransmission of said status inquiring message.

28. The communication system as set forth in claim 27, said channel zap protocol further programmed to:
retransmit said status inquiring message a predetermined number of times to said client terminal device before terminating communication with said client terminal device.

29. The communication system as set forth in claim 27, said channel zap protocol further programmed to:
retransmit said status inquiring message a predetermined number of times;
check for the response message after each retransmission of said status inquiring message; and
terminate said communication with said client terminal device when it determined that the response message was not received by said zapping server after retransmitting said status inquiring message said predetermined number of times.
